(19) United States
(12) Patent Application Publication
(10) Pub. No.: US 2008/0201508 A1
(43) Pub. Date: Aug. 21, 2008

(54) Method And Apparatus For an Enhanced Computer Peripheral Device

(76) Inventors: Dan Gavish, Haifa (IL); Hanna Gavish, Haifa (IL)

Correspondence Address: DAN GAVISH, 4, HARAKAFOT STREET, HAIFA, 34745, omitted

(21) Appl. No.: 12/021,650

(22) Filed: Jan. 29, 2008

Related U.S. Application Data
(60) Provisional application No. 60/890,634, filed on Feb. 20, 2007.

(51) Int. Cl. G06F 13/42

(52) U.S. Cl. 710/106

(57) ABSTRACT

An improved method and apparatus by which a user can send input signals to a computer (including, but not limited to, personal computer, mobile computer, computerized entertainment device, computerized machinery, computerized equipment, etc.) from distance, is disclosed. A receiver unit is embedded into an otherwise conventional computer peripheral device, avoiding the need for dedicated accessories to support a remote control.

### REFERENCE TO RELATED APPLICATIONS

### U.S. Patent Documents

U.S. Pat. No. 6,857,034 February, 2005 DiSanza, et al 710/106

U.S. Pat. No. 7,102,691 September, 2006 Dischert, et al 348/552

U.S. Pat. No. 7,209,116 April, 2007 Gates, et al 345/156

### U.S. Provisional Patent Application

60/890,634 February, 2007 Gavish & Gavish

### FIELD OF THE INVENTION

The present invention relates to the field of computer accessories. In particular, the invention presents a method and apparatus for a computer peripheral device having a wireless “Satellite” Remote-Control.

### BACKGROUND OF THE INVENTION

Computers (including, but not limited to, personal computers, mobile computers, computerized entertainment devices, computerized machinery, computerized equipment, etc.) normally have peripheral devices such as keyboards or mice. In most cases, said peripheral devices are used adjacent to the computer. However, in some cases the user would wish to operate said peripheral devices from distance. For example, when giving a lecture or a presentation, while the computer display is projected on a large screen.

Another example would be operating computerized equipment, machinery or entertainment devices. It would be a lot more desirable if the user can operate said peripheral device from distance using a wireless “satellite”. It would be desired if said wireless satellite does not require any additional accessories to be connected to the computer in addition to said peripheral devices. Furthermore, it would be desired if said wireless satellite operates without any additional software or firmware loaded into said computer.

### PRIOR ART

Several remote control devices for computers exist in the market. However, all existing products require a separate receiver unit to be connected to the computer. The disadvantages of the existing scheme are: (1) The need to deal with another accessory (the receiver unit). This implies not only a higher cost, but also the burden to carry another unit. This burden is annoying especially when using mobile computers. (2) The need to use another input port (such as a USB port) of the computer. This may imply a significant problem when running out of available input ports. (3) The need to install a software driver to support the additional input device. This makes installation more complicated.

Unlike existing products, with the present invention, a separate receiver device is not needed, because the receiver device is embedded with the otherwise conventional computer peripheral device (such as a keyboard or a mouse).

No need to carry a receiver unit, no need to use another input port to install it, and no need to install any software driver. The computer “sees” the computer peripheral device as if it was a conventional one. The computer receives the input operation signals in exactly the same way, no matter whether the user operates the computer peripheral device directly, or through its wireless satellite.

U.S. Pat. No. 6,857,034 issued to DiSanza et al, describes a computer peripheral device incorporating infrared (IR) transmissions. The incorporated IR transmitter serves as a communication link transferring data from the computer to the IR channel. The IR transmitter is integrated into the housing of a computer peripheral. Both devices (IR transmitter and peripheral device) use a USB port connecting to the computer. One drawback of the aforesaid patent is the need for an internal switch that, based on a selection input, selects either the IR module or the peripheral device circuitry to be coupled to the USB connector (as described in DiSanza's patent document, column 2, line 47). Another drawback is: using this prior art with a remote-control, would require a separate IR receiver, and a dedicated software driver. All this implies a higher cost and a higher complexity of installation. In contrast to the prior art, with the current disclosed invention, the peripheral device is controlled by the IR remote control, without the need for a switch, a separate receiver, or a software driver. Whether the peripheral device is controlled by the user directly or via its satellite remote-control, it will still send the same signals to the computer.

U.S. Pat. No. 7,102,691 issued to Dischert et al, describes a method and apparatus for remote use of personal computer. The computer can be operated from distance using an IR remote control. One drawback of the aforesaid patent is: to receive signals from this IR remote control, a dedicated IR receiver should be used (as described in Dischert's patent document, column 3, line 60). Another drawback is: an input selection switch should be used (column 4, line 4) to select either the peripheral device or the remote-control. Also, a software driver should be used to handle the remote-control input. All this implies a higher cost and a higher complexity of installation. In contrast to the prior art, with the current disclosed invention, the peripheral device is controlled by the IR remote control, without the need for a switch, a separate receiver, or a software driver. Whether the peripheral device is controlled by the user directly or via its satellite remote-control, it will still send the same signals to the computer.

U.S. Pat. No. 7,209,116 issued to Gates et al, describes a control device having integrated mouse and remote control capabilities. The same device can be used as either a mouse, or a remote controller. When switching between mouse mode and remote-control mode, it switches between RF and IR transmissions. One drawback of the aforesaid patent is: it requires both IR and RF transmitters and receivers, that implies a higher cost.

Furthermore, the implementation of a suitable range remote control would require an expensive RF circuitry. Alternatively, it would require a dedicated IR receiver (as described in Gates's patent document, column 7 line 36). This implies a higher cost and a higher complexity of installation. In contrast to the prior art, with the current disclosed invention, a low-cost peripheral device is used, and controlled directly by the IR remote control, without the need for a separate receiver. This simplifies installation and reduces cost.

All the aforesaid drawbacks related to the aforesaid prior patents, as well as other existing drawbacks, are resolved with the current disclosed invention, and other advantages are introduced, as will become apparent.

FIG. 6 illustrates one significant improvement of the current disclosed invention over commonly available prior art. With the prior art, Remote Control 601 sends input commands to the computer 607. The receiver 604 of Remote Control 601 is connected to input port 606 of the computer 607. This is in addition to the input port 605 used by the peripheral device 603. Accordingly, this commonly used configuration places an extra burden on the user: the user needs to purchase the receiver device 604; carry and install the receiver device 604; install the software driver for the receiver device 604; and utilize a separate input port 606 for the receiver device 604.

In contrast, with the current disclosed invention, the Remote Control 611 sends commands to the peripheral device 613 rather than sending input commands to the computer 617. The computer's only input device is the peripheral device 613. The computer 617 receives exactly the same input signals from the peripheral device 613, whether the peripheral device 613 is operated directly by the user or through the Remote Control 611. Some of the advantages of the current disclosed invention over the prior art are: (a) no need to purchase, carry and install the remote control receiver, saving the burden and the cost. (b) no need for a separate input port for the remote-control receiver. (c) no need to install software drivers for the remote-control receiver.

These and other advantages are introduced, as will become apparent.

### SUMMARY AND OBJECT OF THE INVENTION

It is one of the objects of the present invention to let the user operate the computer from distance using a wireless satellite.

It is a further object of the present invention to operate said wireless satellite without connecting any accessories to the computer, except the otherwise conventional peripheral devices.

It is still a further object of the present invention to operate said wireless satellite without loading any software or firmware to the computer, except the software required to operate a conventional peripheral devices.

These and other objectives are advantageously achieved by the method and apparatus of the present invention.

The present invention consists of a receiver unit installed within an otherwise conventional computer peripheral device such as a keyboard or a mouse (said computer peripheral device may be connected to the computer with or without wires, or may be integrated within the computer itself) along with a wireless satellite operated by the computer user. By operating said wireless satellite, the user can advantageously operate the computer from distance, performing some operations such as mouse clicking, mouse cursor moving, keyboard inputs, etc.

Said wireless satellite may look similar to a remote control device, or to a mobile phone, or to a palm computer (PDA), or any other embodiment of a wireless device, which can be used to remotely command the computer peripheral device. Said wireless satellite may also be combined with other devices such as a laser pointer.

Said wireless satellite communicates with said receiver unit using any kind of wireless communication. For example, an RF (radio frequency) communication, or, an IR (infra-red) communication, or, any other type of wireless communication may be applied.

Said receiver unit, installed within the otherwise conventional computer peripheral device, receives wireless signals from said wireless satellite, and provides control signals to said computer peripheral device. Accordingly, said computer peripheral device delivers input operation signals to the computer as if the user initiated those operations directly on said computer peripheral device. For example (in this example, the computer peripheral device is a mouse), when the user performs a left-mouse-click operation on the wireless satellite, said satellite transmits a specific wireless signal to the receiver unit (which is installed within the computer mouse). In turn, the receiver unit provides a specific control signal to the mouse regular circuits, which delivers a left-mouse-click operation signal to the computer as if the user has performed a left-mouse-click operation directly on the mouse itself. Yet another example (in this example, the computer peripheral device is a keyboard): when the user hits the “A”-key on the wireless satellite, said satellite transmits a specific wireless signal to the receiver unit (which is installed within the computer keyboard). In turn, the receiver unit provides a specific signal to the keyboard regular circuits, which delivers an “A”-key signal to the computer as if the user has hit the “A” key directly on the keyboard itself.

These and other objects, features, and advantages of the present invention will be apparent to one skilled in the art in view of the descriptions and drawings which follow below.

### BRIEF DESCRIPTION OF THE DRAWINGS

The present invention will be described by examples of embodiments, but not limitations, illustrated in the accompanying drawings, in which:

FIG. 1 illustrates an overall block diagram of the invention.

FIG. 2 represents an example of an embodiment of a computer peripheral device with a wireless satellite, where the computer peripheral device is a mouse. Said mouse may be connected to the computer via wired or wireless port, or else, it may be integrated within the computer itself.

FIG. 3 represents an example of an embodiment of a receiver unit, where IR (infra-red) communication is being used.

FIG. 4 represents an example of an embodiment of a receiver unit, where RF (radio-frequency) communication is being used.

FIG. 5 represents an example of an embodiment of a computer peripheral device with a wireless satellite, where the computer peripheral device is a keyboard. Said keyboard may be connected to the computer via wired or wireless port, or else, it may be integrated within the computer itself.

### DETAILED DESCRIPTION OF THE INVENTION

We hereby present a method and apparatus by which a user can operate a computer from distance using a wireless satellite, without connecting any accessories to the computer, except for the otherwise conventional peripheral devices.

In the following description, for purpose of explanation, specific nomenclature is set forth to provide a thorough understanding of the present invention. However, it will be apparent to one skilled in the art that these specific details are not required in order to practice the present invention. In other instances, well known circuits and devices are shown in block diagram form in order not to obscure the present invention.

The invention will be described by examples of embodiments, but not limitations, illustrated in the accompanying drawings. However, it will be apparent to one skilled in the art that these examples of embodiments are not required in order to practice the present invention, namely, other embodiments of the said invention may be practiced without departing from what is regarded to be the subject matter of the invention.

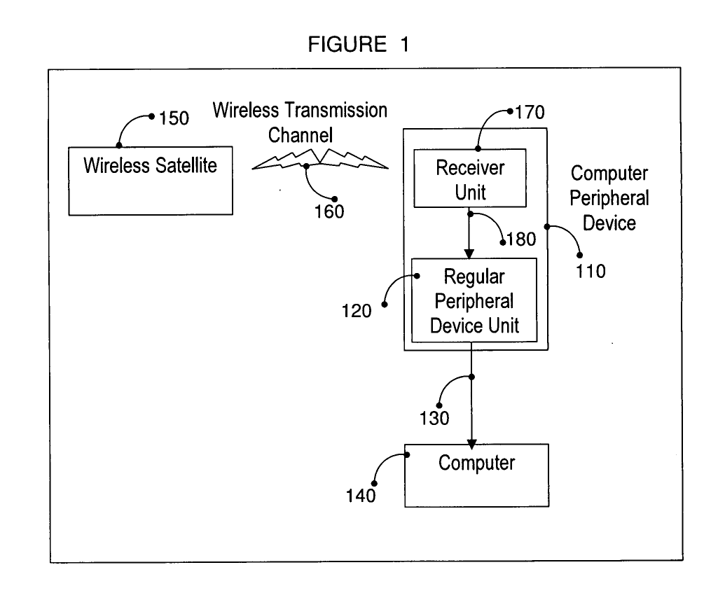

FIG. 1:

FIG. 1 presents an example of an overall functional block diagram of the invention. The otherwise conventional computer peripheral device 110 consists of a regular peripheral device unit 120, with an embedded receiver unit 170. Said computer peripheral device 110 may be a computer mouse, a computer keyboard, or any other peripheral device. Said computer peripheral device 110 may be connected to the computer 140 via wired or wireless port, or else, it may be integrated within the computer itself. When the user operates said peripheral device 110 directly, said regular peripheral device unit 120 delivers input signals 130 to the computer 140. Said input signals 130 may be wired or wireless.

However, the user can perform the same operation from distance by operating the wireless satellite 150. Upon operating of said satellite, it transmits a specific wireless signal 160 to the receiver unit 170. Said wireless signal 160 may utilize an RF (Radio Frequency) transmission, or an IR (Infra Red) transmission, or an ultra-sonic transmission, or any other method of wireless transmission. In turn, said receiver unit 170 provides a specific input signal 180 to the regular peripheral device unit 120. As a result, said regular peripheral device unit 120 delivers input signals 130 to the computer 140, as if the user has operated said computer peripheral device 110 directly.

Implementation of said circuits will be apparent to one skilled in the art.

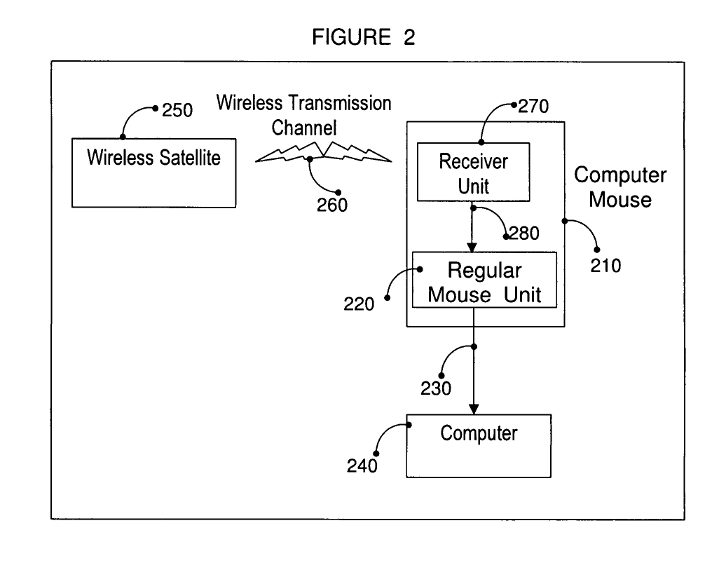

FIG. 2:

FIG. 2 represents an example of an embodiment of a computer peripheral device with a wireless satellite, where the computer peripheral device is a mouse. Said mouse may be connected to the computer via wired or wireless port, or else, it may be integrated within the computer itself.

The otherwise conventional computer mouse 210 consists of a regular mouse unit 220, with an embedded receiver unit 270. Said computer mouse 210 may be connected to the computer 240 via wired or wireless port, or else, it may be integrated within the computer itself.

When the user operates said computer mouse 210 directly, said regular mouse unit 220 delivers input signals 230 to the computer 240. Said input signals 230 may be wired or wireless.

However, the user can perform the same operation from distance by operating the wireless satellite 250. Upon operating of said satellite, it transmits a specific wireless signal 260 to the receiver unit 270. Said wireless signal 260 may utilize an RF (Radio Frequency) transmission, or an IR (Infra Red) transmission, or an ultra-sonic transmission, or any other method of wireless transmission. In turn, said receiver unit 270 provides a specific input signal 280 to the regular mouse unit 220. As a result, said regular mouse unit 220 delivers input signals 230 to the computer 240, as if the user has operated said computer mouse 210 directly.

Implementation of said circuits of this example of embodiment will be apparent to one skilled in the art.

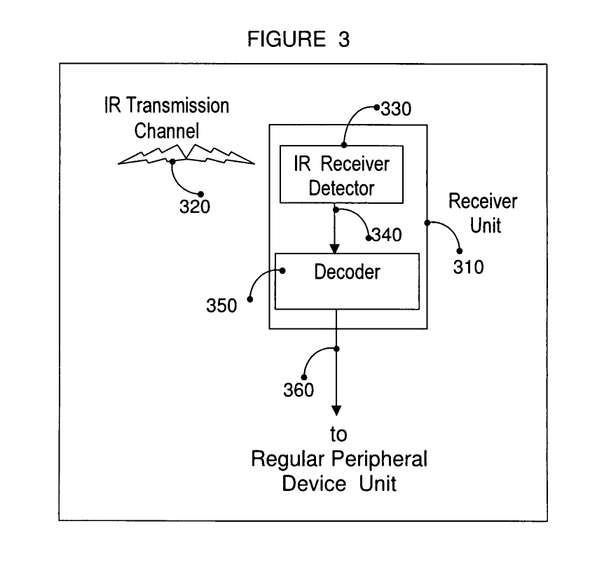

FIG. 3:

FIG. 3 represents an example of an embodiment of a receiver unit 310, where IR (infra-red) communication is being used. The receiver unit 170 of the system presented in FIG. 1 above is described here in more depth.

The IR receiver detector 330 receives the IR signals 320 from the satellite, and converts them into digital signals 340. The decoder 350 receives said digital signals 340 and decodes them to determine the specific user operation. In turn, said decoder 350 delivers input signals 360 to the regular peripheral device unit of the otherwise conventional computer peripheral device.

Implementation of said circuits of this example of embodiment will be apparent to one skilled in the art.

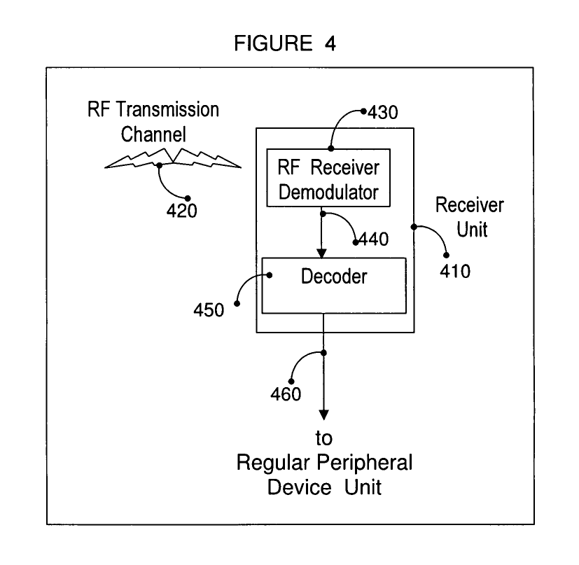

FIG. 4:

FIG. 4 represents an example of an embodiment of a receiver unit 410, where RF (radio-frequency) communication is being used. The receiver unit 170 of the system presented in FIG. 1 above is described here in more depth.

The RF receiver demodulator 430 receives the RF signals 420 from the satellite, and converts them into digital signals 440. The decoder 450 receives said digital signals 440 and decodes them to determine the specific user operation. In turn, said decoder 450 delivers input signals 460 to the regular peripheral device unit of the otherwise conventional computer peripheral device.

Implementation of said circuits of this example of embodiment will be apparent to one skilled in the art.

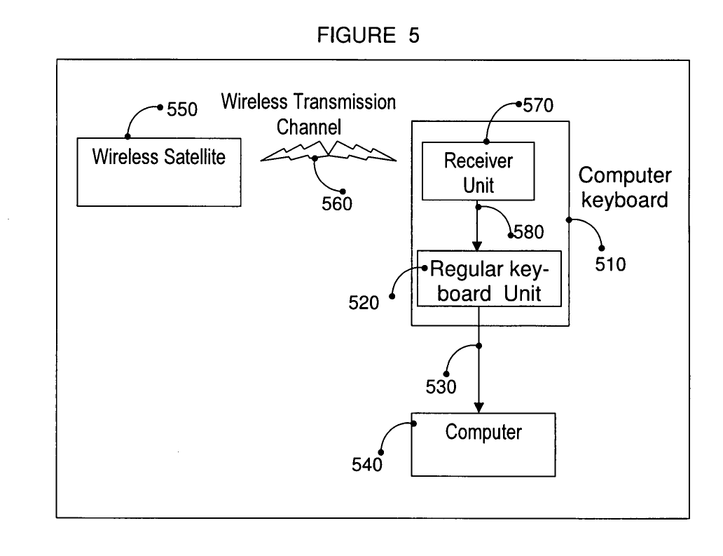

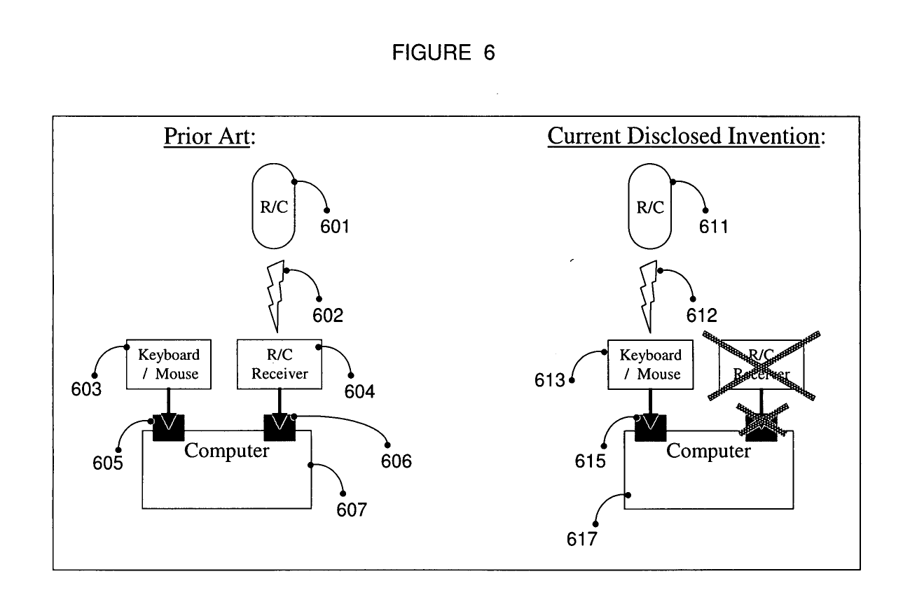

FIG. 5:

FIG. 5 represents an example of an embodiment of a computer peripheral device with a wireless satellite, where the computer peripheral device is a keyboard. Said keyboard may be connected to the computer via wired or wireless port, or else, it may be integrated within the computer itself.

The otherwise conventional computer keyboard 510 consists of a regular keyboard unit 520, with an embedded receiver unit 570. Said computer keyboard 510 may be connected to the computer 540 via wired or wireless port, or else, it may be integrated within the computer itself.

When the user operates said computer keyboard 510 directly, said regular keyboard unit 520 delivers input signals 530 to the computer 540. Said input signals 530 may be wired or wireless.

However, the user can perform the same operation from distance by operating the wireless satellite 550. Upon operating of said satellite, it transmits a specific wireless signal 560 to the receiver unit 570. Said wireless signal 560 may utilize an RF (Radio Frequency) transmission, or an IR (Infra Red) transmission, or an ultra-sonic transmission, or any other method of wireless transmission. In turn, said receiver unit 570 provides a specific input signal 580 to the regular keyboard unit 520. As a result, said regular keyboard unit 520 delivers input signals 530 to the computer 540, as if the user has operated said computer keyboard 510 directly.

Implementation of said circuits of this example of embodiment will be apparent to one skilled in the art.

Referring back to all the examples of embodiments described above: to avoid undesired remote operation in case that a wireless satellite is not being used, the computer peripheral device may be designed so that the user can turn its remote operation capability on or off. One example of implementation of this feature is using a simple switch. Another example of implementation of this feature is: upon normal power up of the computer peripheral device, it automatically turns-off its remote operation capability. However, if one of the device's keys or buttons is being pressed during power-up (when the device is connected to the computer), then it turns-on its remote operation capability. Implementation of said examples will be apparent to one skilled in the art.

In the foregoing specification the invention has been described with reference to specific examples of embodiments thereof. It will, however, be evident that various modifications and changes may be made thereto without departing from what is regarded to be the subject matter of the invention, or the broader spirit and scope of the invention. The specification and drawings are, accordingly, to be regarded in an illustrative rather than restrictive sense.

What is claimed is:

1. An enhanced computer peripheral device, said enhanced computer peripheral device comprising:
a) a computer peripheral device, equipped to convey input signals to a computer, said computer is selected from the list including but not limited to personal computer, mobile computer, computerized entertainment device, computerized machinery, computerized equipment;
b) a receiver unit, equipped to receive wireless transmission from a wireless transmitter; said wireless transmission is selected from the list including but not limited to RF (radio frequency) wireless transmission, IR (infra-red) wireless transmission.

2. An enhanced computer peripheral device as set forth in claim 1 wherein said computer peripheral device is a computer mouse.

3. An enhanced computer peripheral device as set forth in claim 1 wherein said computer peripheral device is a keyboard.

4. An enhanced computer peripheral device as set forth in claim 1 wherein said wireless transmission is RF (radio frequency) wireless transmission.

5. An enhanced computer peripheral device as set forth in claim 1 wherein said wireless transmission is IR (infra red) wireless transmission.

6. A peripheral device system, said peripheral device system comprising:
a) an enhanced computer peripheral device as set forth in claim 1;
b) a wireless transmitter, equipped to transmit wireless signals to said enhanced computer peripheral device.

7. An enhanced computer system, said enhanced computer system comprising:
a) a computer, said computer is selected from the list including but not limited to personal computer, mobile computer, computerized entertainment device, computerized machinery, computerized equipment;
b) an enhanced computer peripheral device as set forth in claim 1.

8. A method for remotely controlling a computer peripheral device; said computer peripheral device equipped with a receiver unit; said method comprising:
a) receiving a wireless transmission from a remote transmitter, said wireless transmission is selected from the list including but not limited to RF (radio frequency) wireless transmission, IR (infra-red) wireless transmission;
b) decoding said wireless transmission;
c) delivering an input signal to a computer, said computer is selected from the list including but not limited to personal computer, mobile computer, computerized entertainment device, computerized machinery, computerized equipment.

9. A method as set forth in claim 8 where said wireless transmission is RF (radio frequency) wireless transmission.

10. The method as set forth in claim 8 where said wireless transmission is IR (infra red) wireless transmission.
